(19) United States
(12) Patent Application Publication
(10) Pub. No.: US 2026/0160004 A1
(43) Pub. Date: Jun. 11, 2026

(54) Wiping Product with Topographical Pattern

(71) Applicant: Kimberly-Clark Worldwide, Inc., Neenah, WI (US)

(72) Inventors: Jean F. Niemeyer, Appleton, WI (US); Andrew T. Baker, Norcross, GA (US); Divesh Bhatt, Missoula, MT (US); Yabo Guan, Alpharetta, GA (US); Ning Yang, Suwanee, GA (US); Michael Payne, Acworth, GA (US); Samantha J. Zellefrow, Atlanta, GA (US); Biao Feng, Johns Creek, GA (US)

(21) Appl. No.: 19/125,985

(22) PCT Filed: Nov. 1, 2023
(86) PCT No.: PCT/US2023/036575

§ 371 Date: Apr. 30, 2025

Related U.S. Application Data
(60) Provisional application No. 63/421,596, filed on Nov. 2, 2022.

(51) Int. Cl. D04H 1/495; B08B 1/14; D04H 1/425; D04H 1/435; D04H 1/4382

(52) U.S. Cl. CPC D04H 1/495; B08B 1/143; D04H 1/425; D04H 1/435; D04H 1/43835; D10B 2201/20; D10B 2331/04; D10B 2403/01

(57) ABSTRACT

A nonwoven material is disclosed that includes a surface topography well suited for cleaning up contaminants, especially oil and/or grease.

### CROSS REFERENCE TO RELATED APPLICATIONS

This application claims priority to the benefit of U.S. Provisional Application No. 63/421,596, filed Nov. 2, 2022 which is expressly incorporated herein by reference in its entirety.

### BACKGROUND

Domestic and industrial wipers are often used to pick up and absorb both polar liquids and non-polar liquids. The wipers should be constructed to have a sufficient absorption capacity to hold a liquid within the wiper structure. In addition, the wipers should also possess good physical strength and abrasion resistance to withstand the tearing, stretching and abrading forces often applied during use.

Conventional wiping products have been made from woven and knitted fabrics. Such wipers have been used in all different types of industries, such as for industrial applications, food service applications, health and medical applications, and for general consumer use.

In the past, nonwoven wipers have also been constructed made from pulp fibers alone or in combination with synthetic fibers. For example, in the past, spunbond webs made from continuous filaments have been hydroentangled with pulp fibers in order to produce a resilient wiping product. In many instances, these webs are for single use applications and then disposed. Although these wipers possess good levels of strength and absorbency, the wipers typically do not possess the same cleaning characteristics as woven and knitted fabrics, particularly when wiping up oil and grease.

In view of the above, a need currently exists for a disposable nonwoven wiper that has improved oil and grease cleaning efficacy. A need also exists for a disposable nonwoven wiper that is well suited to cleaning oil and grease spills at a relatively low basis weight, especially in comparison to woven and knitted cleaning cloths.

### SUMMARY

In general, the present disclosure is directed to nonwoven webs or basesheets having excellent oil and grease cleaning efficacy. The nonwoven webs are particularly well suited for use as industrial wipers. Although well adapted to picking up oil and grease, the wipers can also be used in various other applications. In particular, the wipers possess excellent absorbency characteristics in combination with good strength characteristics. In accordance with the present disclosure, the nonwoven webs of the present disclosure have a particular topography for maximizing grease removal and oil absorption.

In one embodiment, for instance, the present disclosure is directed to a wiping product comprising a nonwoven web having a first surface and a second and opposite surface. The nonwoven web contains cellulose fibers, synthetic polymer fibers, or a mixture of cellulose fibers and synthetic polymer fibers. In one aspect, the nonwoven web has a basis weight of less than about 110 gsm. A topographical pattern is located on the first surface of the nonwoven web. At least a portion of the topographical pattern includes raised pattern elements that extend from a base surface. The raised pattern of elements produce a perimeter of pattern elements per surface area of greater than about 0.08/mm and produce a pattern created volume per surface area of greater than about 1.1 mm when tested at 0.3 psi.

For example, the raised pattern elements can produce a perimeter of pattern elements per surface area of greater than about 0.09/mm, such as greater than about 0.1/mm, such as greater than about 0.11/mm, and even greater than about 0.12/mm when tested at 0.3 psi. The raised pattern elements can produce a pattern created volume per surface area of greater than about 1.3 mm, such as greater than about 1.4 mm, such as greater than about 1.5 mm, such as greater than about 1.6 mm, when tested at 0.3 psi.

The nonwoven web can have a void volume of greater than about 75%, such as greater than about 78%, such as greater than about 80%, such as greater than about 82%, when tested at 0.3 psi. The nonwoven web can have a density of from about 0.1 g/cm³ to about 0.18 g/cm³, such as from about 0.12 g/cm³ to about 0.14 g/cm³, when tested at a pressure of 0.05 psi.

In one aspect, the raised pattern elements of the pattern comprise discrete shapes that are not interconnected. The basis weight of the nonwoven web where the raised pattern elements are located can be greater than the basis weight of the nonwoven web in areas where there are no raised pattern elements (e.g. the basis weight of the base surface). For instance, the basis weight of the nonwoven web within the raised pattern elements can be greater than about 10%, such as greater than about 20%, such as greater than about 30%, such as greater than about 40% of the basis weight of the nonwoven web where no raised pattern elements are located. In one aspect, the raised pattern elements comprise raised circular elements. The raised pattern elements can have a perimeter of from about 0.5 mm to about 20 mm, such as from about 0.75 mm to about 10 mm, such as from about 1.5 mm to about 5 mm. In one embodiment, the topographical pattern of the nonwoven web can further include contaminant retention zones. The raised pattern elements, for instance, can form raised pattern zones that border the contaminant retention zones. The contaminant retention zones can be substantially planar and devoid of raised pattern elements. In one aspect, the contaminant retention zones can comprise discrete zones that are not interconnected.

The raised pattern elements can have a height (measured from the base surface) of greater than about 0.1 mm, such as greater than about 0.2 mm, such as greater than about 0.3 mm, such as greater than about 0.4 mm, such as greater than about 0.5 mm, such as greater than about 0.6 mm, and generally less than about 1.2 mm, such as less than about 1 mm, such as less than about 0.8 mm. Similar to density, the height of the raised pattern elements can be measured at a pressure of 0.05 psi. The raised pattern elements can be spaced apart in any suitable amount. In one embodiment, the raised pattern elements are spaced apart an average distance of from about 0.5 mm to about 1.5 mm. The nonwoven web can have a caliper measured from a top of the raised pattern elements of greater than about 0.4 mm, such as greater than about 0.8 mm, such as greater than about 1.2 mm, such as greater than about 1.5 mm, such as greater than about 2 mm, such as greater than about 2.5 mm, and less than about 5 mm such as less than about 3 mm, such as less than about 1 mm, when tested at a pressure of 0.05 psi.

The nonwoven web can have a basis weight of from about 35 gsm to about 100 gsm, such as from about 50 gsm to about 90 gsm, such as from about 50 gsm to about 70 gsm. In one aspect, the nonwoven web contains synthetic polymer fibers in an amount from about 5% to about 65% by weight, such as from about 15% by weight to about 45% by weight, and contains cellulose fibers in an amount from about 35% to about 95% by weight, such as from about 55% by weight to about 85% by weight. The nonwoven web can also contain binder fibers and/or a wet strength agent. The nonwoven web can comprise a foam formed web and can contain residual amounts of the surfactant. The raised pattern elements can occupy from about 15% to about 80% of the surface area of the first surface, such as from about 20% to about 60% of the surface area of the first surface. In one aspect, the topographical pattern includes first raised pattern elements and second raised pattern elements. The first raised pattern elements can have a perimeter that is less than a perimeter of the second raised pattern elements.

In one aspect, the synthetic polymer fibers comprise polyester fibers. The polyester fibers can have a fiber size of from about 0.5 denier to about 3 denier. In one aspect, the synthetic polymer fibers can comprise first polyester fibers and second polyester fibers. The first polyester fibers can have a fiber size of less than about 1.5 denier. The first polyester fibers can have a smaller size than the second polyester fibers.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of one embodiment of a nonwoven material made in accordance with the present disclosure;

FIG. 2 is a perspective view of another embodiment of a nonwoven material made in accordance with the present disclosure;

FIG. 3 is a cross-sectional view of one embodiment of a nonwoven material made in accordance with the present disclosure shown with applied pressure against the nonwoven material against an adjacent surface that simulates use of the product;

FIG. 4 is a schematic diagram of one embodiment of a process for forming a nonwoven material in accordance with the present disclosure; and

FIG. 5 is a schematic diagram of an enlarged partial view of the schematic diagram illustrated in FIG. 4.

Repeat use of reference characters in the present specification and drawings is intended to represent the same or analogous features or elements of the present invention.

### Definitions

The term “machine direction” as used herein refers to the direction of travel of the forming surface onto which fibers are deposited during formation of a nonwoven web.

The term “cross-machine direction” as used herein refers to the direction which is perpendicular to the machine direction defined above.

The term “cellulose fibers” as used herein refers to fibers from natural sources such as woody and non-woody plants. Woody plants include, for example, deciduous and coniferous trees. Non-woody plants include, for example, cotton, flax, esparto grass, milkweed, straw, jute, hemp, and bagasse. “Pulp fibers” refers to delignified cellulose fibers and can include hardwood fibers, softwood fibers, and mixtures thereof.

The term “average fiber length” as used herein refers to an average length of fibers, fiber bundles and/or fiber-like materials determined by measurement utilizing microscopic techniques. A sample of at least 20 randomly selected fibers is separated from a liquid suspension of fibers. The fibers are set up on a microscope slide prepared to suspend the fibers in water. A tinting dye is added to the suspended fibers to color cellulose-containing fibers so they may be distinguished or separated from synthetic fibers. The slide is placed under a Fisher Stereomaster II Microscope—S19642/S19643 Series. Measurements of 20 fibers in the sample are made at 20× linear magnification utilizing a 0-20 mils scale and an average length, minimum and maximum length, and a deviation or coefficient of variation are calculated. In some cases, the average fiber length will be calculated as a weighted average length of fibers (e.g., fibers, fiber bundles, fiber-like materials) determined by equipment such as, for example, a Kajaani fiber analyzer Model No. FS-200, available from Kajaani Oy Electronics, Kajaani, Finland. According to a standard test procedure, a sample is treated with a macerating liquid to ensure that no fiber bundles or shives are present. Each sample is disintegrated into hot water and diluted to an approximately 0.001% suspension. Individual test samples are drawn in approximately 50 to 100 ml portions from the dilute suspension when tested using the standard Kajaani fiber analysis test procedure. The weighted average fiber length may be an arithmetic average, a length weighted average or a weight weighted average and may be expressed by the following equation:

$${\sum }_{{x}_{i} = 0}^{k} ( {x}_{i} * {n}_{i} ) / n$$

$$where$$

$$k = maximum fiber length$$

$${x}_{i} = fiber length$$

$${n}_{i} = number of fibers having length xi$$

$$n = total number of fibers measured .$$

One characteristic of the average fiber length data measured by the Kajaani fiber analyzer is that it does not discriminate between different types of fibers. Thus, the average length represents an average based on lengths of all different types, if any, of fibers in the sample.

As used herein, the term “staple fibers” means discontinuous fibers made from synthetic polymers such as polypropylene, polyester, post-consumer recycle (PCR) fibers, polyester, nylon, and the like, or cellulose fibers such as cotton fibers, bast fibers, regenerated cellulose fibers (e.g. viscose, rayon, etc.), and the like. Staple fibers may be cut fibers or the like. Staple fibers can have cross-sections that are round, bicomponent, multicomponent, shaped, hollow, or the like.

As used herein, the term “nonwoven web or material” refers to a web having a structure of individual fibers, yarns or mixtures thereof that are interlaid, but not in an identifiable manner as in a knitted or woven fabric. Nonwoven materials include, for example, carded webs, wet-laid webs, airlaid webs, foam-formed webs, and the like.

As used herein the term “caliper” is the representative thickness of a single sheet (caliper of tissue products comprising two or more plies is the thickness of a single sheet of tissue product comprising all plies) measured in accordance with TAPPI test method T402 using an EMVECO 200-A Microgage automated micrometer (EMVECO, Inc., Newberg, Oreg.). The micrometer has an anvil diameter of 2.22 inches (56.4 mm) and an anvil pressure of 132 grams per square inch (per 6.45 square centimeters) (2.0 kPa).

As used herein the term “sheet bulk” refers to the quotient of the caliper (generally having units of μm) divided by the bone dry basis weight (generally having units of gsm).

As used herein, “void volume” is the amount of space inside the nonwoven material not taken up by solid material, such as fibers. In one aspect, void volume per surface area can be determined. Void volume can be determined at an applied pressure, such as at a pressure of 0.05 psi or 0.3 psi.

As used herein, the “height of the raised pattern elements” is the height of the pattern elements above the base surface of the nonwoven material. The height of the raised pattern elements is measured at 0.05 psi.

As used herein, the “void surface area” is the area of the base surface of the nonwoven material that is void of raised pattern elements.

As used herein, the “pattern created volume” is the void volume between the base surface of the nonwoven web and a plane that is in contact with the top surface of the raised pattern elements at an applied pressure of 0.3 psi. The pattern created volume can be calculated per unit of surface area of the nonwoven material.

As used herein, the “perimeter of pattern elements” is the distance around the edges of the raised pattern elements and is determined at an applied pressure of 0.3 psi. The perimeter of pattern elements can be based on per unit surface area of the nonwoven material.

The method for determining the “pattern created volume” and the “perimeter of pattern elements” is conducted using the following method.

The method for determining the contact perimeter, pattern created void volume per unit area, and void volume includes the first step of acquiring digital x-ray Micro-CT images of a sample. These images are acquired using a SkyScan 1272 Micro-CT system available from Bruker microCT (2550 Kontich, Belgium). A circular ¾ inch cut-out diameter sample is attached flat to a mounting apparatus, supplied by Bruker with the SkyScan 1272 system, so that it will not move under its own weight during the scanning process. In addition to the sample by itself, weights of 20, 50 and 100 grams are also placed on top of the sample prior to Micro-CT scanning. The following SkyScan 1272 conditions are used during the scanning process:

$$Source Voltage ( k V ) = 30$$

$$Source Current ( uA ) = 200$$

$$Image Pixel Size ( um ) = 5.$$

$$Image Format = TIFF$$

$$Rotation Step ( deg . ) = 0.1$$

$$Use 360 Rotation = NO$$

$$Frame Averaging = ON ( 6 )$$

$$Random Movement = ON ( 1 )$$

$$Flat Field Correction = ON$$

$$Filter = No Filter$$

After sample scanning is completed, the resulting X-ray image set is then reconstructed using the NRecon program provided with the SkyScan 1272 Micro-CT system. While reconstruction parameters can be somewhat sample dependent, and should be known to those skilled in the art, the following parameters should provide a basic guideline to an analyst:

$$Image File Type = JPG$$

$$Pixel Size ( um ) = 5.$$

$$Smoothing = 1 ( Gaussian )$$

$$Ring Artifact Correction = 7$$

$$Beam Hardening Correction ( \% ) = 10$$

After reconstruction is completed, the resulting image data set is now ready for percent internal porosity and object surface area/volume measurements analysis using the Bruker SkyScan software package called CTAn. After downloading the entire reconstructed image data set into CTAn, the analyst, skilled in the art of Micro-CT technologies, must then perform pre-analysis processing such as grayscale thresholding and despeckling. Finally, a shrink-wrap region-of-interest (ROI) is performed so that the material fibers are completely encased within the ROI. Now the 3D analysis can be selected and performed using the standard void volume and porosity parameters. When completed, the 3D results are available in a. txt file in the same folder that the reconstructed images slices reside. Lastly, the CTAn software Save Bitmaps command is used to save the ROI image slices for subsequent image analysis.

In addition to the internal porosity and surface/volume analyses, the ROI image slices can also be analyzed using image analysis for pattern created void volume per analysis region area from the top material surface to the underlying material region that is completely occupied by the fibrous material structure. The top material perimeter of pattern elements per analysis region area is also measured from the ROI image slices.

The image analysis software platform used to perform the pattern created void volume and perimeter of pattern element measurements can either be a QWIN Pro (Version 3.5.1) or LAS (Version 14.3) available from Leica Microsystems, having an office in Heerbrugg, Switzerland.

Thus, the method for determining the pattern created void volume and perimeter of pattern element measurements of a given sample includes the step of performing measurements on the ROI image slices from the Micro-CT image set. Specifically, an image analysis algorithm is used to read and process images as well as perform measurements using Quantimet User Interactive Programming System (QUIPS) language. The image analysis algorithm is reproduced below.

```
NAME = ROI Shrink Wrap Area, % Area & Perimeter (micro-CT)
PURPOSE = Measures wipe % area, area, perimeter and void volume using shrink wrap ROI
CONDITIONS = Images acquired on SkyScan 1272 and CTAn processing
AUTHOR = D. G. Biggs
DATE = August 26, 2022
ENTER SAMPLE ID & OPEN DATA FILE
  Configure (Image Store 1392 x 1040, Grey Images 348, Binaries 24)
  PauseText (″Enter EXCEL data file name now.″)
  Input (FILENAME$)
  OPENFILE$ = ″C:\Data\03126 - Baker\″+FILENAME$+″.xls″
  Open File (OPENFILE$, channel #CHAN)
  CALIBRATE IMAGE
  - Calvalue = 0.05 mm/px
  CALVALUE = 0.05
  Calibration (Local)
  Enter Results Header
  File Results Header (channel #1)
  File Line (channel #1)
  REPLICATE = 0
  SAMPLE = 0
  ACQOUTPUT = 0
  SET-UP
  PauseText (″Enter complete image pre-fix name″)
  Input (TITLE$)
  File (TITLE$, channel #1)
  File Line (channel #1)
  File (″ROI image No.″, channel #1)
  File (″% Area″, channel #1)
  File (″Area (sq. mm)″, channel #1)
  File (″Perimeter (mm)″, channel #1)
  File (″Void Area (sq. mm)″, channel #1)
  File Line (channel #1)
  Image frame (x 0, y 0, Width 3964, Height 3964)
  Measure frame (x 846, y 740, Width 2475, Height 2604)
  -- Comment: The following line is set prior to executing the algorithm to read the ROI image
numbers.
  For (SAMPLE = 1437 to 1229, step −1)
  ACQUIRE IMAGE
  ACQOUTPUT = 0
    -- Comment: The following line must be set to read from the directory where images are located.
  ACQFILE$ = ″C:\Images\03126 - Baker\ROI Images\WAVE No
load\″+TITLE$+″″+STR$(SAMPLE)+″.jpg″
  Read image (from file ACQFILE$ into ACQOUTPUT)
  Colour Transform (Mono Mode)
  DETECTION AND IMAGE PROCESSING
  PauseText (″Select optimal gray detection″)
  Detect (whiter than 64, from Image0 into Binary0)
  Detect (blacker than 194, from Image0 into Binary4)
  Binary Amend (Open from Binary0 to Binary1, cycles 6, operator Disc, edge erode on)
  Binary Amend (Close from Binary1 to Binary2, cycles 5, operator Disc, edge erode on)
  Binary Identify (FillHoles from Binary2 to Binary3)
  Binary Logical (C = A OR B: C Binary5, A Binary3, inverted, B Binary4)
  FIELD MEASUREMENTS
  Measure frame (x 846, y 740, Width 2475, Height 2604)
  MFLDIMAGE = 3
  Measure field (plane MFLDIMAGE, into FLDRESULTS(3), statistics into FLDSTATS(7,3) )
    Selected parameters: Area, Perimeter, Area%
  AREA = FLDRESULTS(1)
  PERIM = FLDRESULTS(2)
  PERCAREA = FLDRESULTS(3)
  MFLDIMAGE = 5
  Measure field (plane MFLDIMAGE, into FLDRESULTS(1), statistics into FLDSTATS(7,1) )
    Selected parameters: Area
  VOIDAREA = FLDRESULTS(1)
  OUTPUT
  File (SAMPLE, channel #1, 0 digits after ′.’)
  File (PERCAREA, channel #1, 1 digit after ′.′)
  File (AREA, channel #1, 1 digit after ′.′)
  File (PERIM, channel #1, 1 digit after ′.′)
  File (VOIDAREA, channel #1, 1 digit after ′.′)
  File Line (channel #1)
  Next (SAMPLE)
  File Line (channel #1)
  File Line (channel #1)
  Close File (channel #1)
END
```

The algorithm is executed using the Leica QWIN or LAS platform. Once the algorithm has analyzed the designated images, raw data results can be found in an EXCEL file located at the designated computer hard drive folder shown at the Open File line above. The data column headings will include ROI image number, % area, area, and perimeter of the ROI and void area of the non-ROI region. The void volume measurement is calculated by adding all of the void area measurements from the lowest ROI % area measurement all the way down to highest percent area measurement. This value is multiplied by the pixel calibration factor (i.e., 0.05 mm) and then dividing by the area of the measurement frame (i.e., 16,122 sq. mm). The perimeter per area is calculated by averaging the top three perimeter of pattern element values and then dividing this value by the area of the measurement frame as shown above.

The above measurements can occur at an applied pressure. The pressure, for instance, can be 0 psi, 0.1 psi, 0.2 psi, 0.3 psi, 0.4 psi, 0.5 psi, 0.6 psi, 0.7 psi, or 0.8 psi. In one aspect, for instance, the measurements are conducted at an applied pressure of 0.3 psi.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to nonwoven materials that are designed with a particular topography that has been found to provide numerous advantages and benefits. The topography can include a pattern of raised elements that extend from a base surface of the nonwoven material. Various different properties of the raised elements and the nonwoven material are controlled in order to produce a nonwoven material with enhanced cleaning properties. For instance, in one aspect, the nonwoven material can be used as a wiper, such as an industrial wiper, that has improved oil and/or grease cleaning efficacy.

More particularly, the nonwoven material of the present disclosure includes a pattern of raised elements that can have, for instance, a cylindrical-like shape that extends from a base surface of the nonwoven material. The raised elements are spaced apart in a pattern that produces improvements in grease and/or oil removal from a surface. For instance, the raised pattern elements have a height that creates a void volume between the base surface of the nonwoven material and the top of the raised elements. This void volume is well suited for trapping contaminants, such as grease and oil. In addition, the raised elements produce a perimeter of pattern elements that are comprised of edges of the raised elements for contacting contaminants, such as grease and/or oil, and collecting those contaminants in the void surface area.

In addition to the topography, nonwoven materials made according to the present disclosure can also be produced using a fiber furnish and process that not only creates the topography, but also produces a nonwoven basesheet with other optimal properties including porosity or void volume, absorbency characteristics, and mechanical strength. Of particular advantage, nonwoven webs made according to the present disclosure can be designed to pick up oil and/or grease in the same amount as a woven or knitted cloth, but at a basis weight of less than about 20%, such as less than about 30%, such as less than about 40%, such as even less than about 50% of the basis weight of the conventional cloth material.

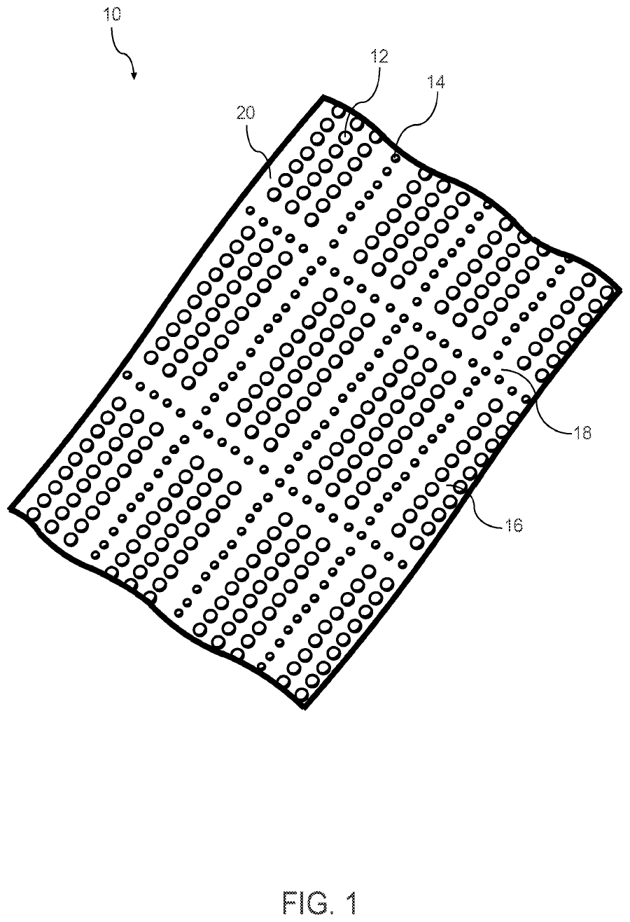

Referring to FIG. 1, one embodiment of a nonwoven material 10 made in accordance with the present disclosure is shown. As illustrated, the nonwoven material 10 includes a pattern of raised elements. In the embodiment illustrated in FIG. 1, for instance, the pattern includes first raised pattern elements 12 and second raised pattern elements 14. The first raised pattern elements 12 have a perimeter that is greater than the perimeter of the second raised pattern elements 14. In this embodiment, the first raised pattern elements 12 are located in domains comprised of columns and rows. The domains of the first raised pattern elements 12 are separated by a grid pattern of the second raised pattern elements 14. As will be described in greater detail below, this pattern is merely exemplary and may be comprised of just one of many, numerous patterns that may be made in accordance with the present disclosure. In addition, other patterns may only include a single raised pattern element size or may include more than two raised elements having different sizes.

As shown in FIG. 1, in one aspect, the raised elements can comprise discrete shapes that are not interconnected. In the embodiment illustrated in FIG. 1, the raised elements have a cylindrical shape with a generally circular top surface. This circular shape as shown in FIG. 1 may provide various advantages and benefits when used to pick up grease and/or oil. In other embodiments, however, the shape of the raised elements can vary. For instance, the shape of the raised elements can be irregular or can comprise any suitable geometric shape, such as rectangular, triangular, oval, or the like. In one aspect, discrete shapes can be combined with elongated interconnected shapes. For instance, discrete, individual shapes can be combined with a grid-like raised pattern.

As illustrated in FIG. 1, the pattern of raised elements form void areas 16 on a base surface 20 of the nonwoven material 10. The void areas 16 and the base surface 20, for instance, can be substantially planar. The raised pattern elements 12 and 14 can extend from the base surface 20.

Between and surrounding the first raised pattern elements 12 and the second raised pattern elements 14 are void areas 16. These void areas produce a void surface area volume spaced between the base surface 20 and the top of the raised pattern elements 12 and 14. The amount and spacing of these void areas 16 can have an effect and can impact the ability of the nonwoven material 10 to clean and hold grease and/or oil substances. As shown in FIG. 1, void areas 16 can have different sizes and shapes on the base surface 20. For example, larger void areas can produce contaminant retention zones 18. The contaminant retention zones 18, in some embodiments, can provide surface area for holding and retaining contaminants. The contaminant retention zones 18 may also improve the liquid absorbency properties of the nonwoven material 10 in certain applications. In the embodiment illustrated in FIG. 1, the contaminant retention zones 18 are not interconnected and instead are separated by the second raised pattern elements 14. In other embodiments, however, the contaminant retention zones 18 can be interconnected and form a grid over the surface of the nonwoven material 10.

The raised pattern elements 12 and 14 can have any suitable size as long as the raised elements generate enough edges for cleaning efficacy. In general, the raised pattern elements can have a perimeter of greater than about 0.5 mm, such as greater than about 0.75 mm, such as greater than about 1 mm, such as greater than about 1.5 mm, such as greater than about 2 mm, such as greater than about 2.5 mm, such as greater than about 2.75 mm, such as greater than about 3 mm. The perimeter of the raised pattern elements is generally less than about 20 mm, such as less than about 10 mm, such as less than about 7 mm, such as less than about 5 mm, such as less than about 3 mm, such as less than about 2.5 mm, such as less than about 2 mm, such as less than about 1.75 mm. As shown in FIG. 1, the nonwoven material 10 can include raised pattern elements having different sizes. For example, in one aspect, the first raised pattern elements 12 can have a perimeter of from about 1 mm to about 2.5 mm, while the second raised pattern elements 14 can have a perimeter of from about 0.5 mm to about 1.5 mm.

Within each pattern domain, the raised pattern elements can be spaced a distance that produces sufficient void areas 16 while also producing sufficient edges of the raised pattern elements. The spacing can be measured from the edge of one raised element to the edge of an adjacent raised element along a line that intersects the center of each raised element. The spacing between raised elements within a domain or pattern area can be generally greater than about 0.2 mm, such as greater than about 0.3 mm, such as greater than about 0.5 mm, such as greater than about 0.7 mm, such as greater than about 0.9 mm, such as greater than about 1.1 mm, such as greater than about 1.3 mm, such as greater than about 1.5 mm, such as greater than about 1.7 mm, such as greater than about 1.9 mm, such as greater than about 2.1 mm, such as greater than about 2.3 mm. The spacing between adjacent pattern elements is generally less than about 5 mm, such as less than about 4 mm, such as less than about 3 mm, such as less than about 2.75 mm, such as less than about 2.5 mm, such as less than about 2.25 mm, such as less than about 2 mm, such as less than about 1.8 mm, such as less than about 1.6 mm, such as less than about 1.4 mm, such as less than about 1.2 mm, such as less than about 1 mm, such as less than about 0.8 mm.

The height of the raised pattern elements can be measured at a pressure of 0.05 psi and can be measured from the top of a pattern element to the base surface 20. The height of the raised elements can be uniform or can vary over the surface of the nonwoven web. In general, the height of the raised elements can be greater than about 0.2 mm, such as greater than about 0.5 mm, such as greater than about 0.7 mm, such as greater than about 0.9 mm, such as greater than about 1.1 mm. The height of the raised elements is generally less than about 2 mm, such as less than about 1.7 mm, such as less than about 1.5 mm, such as less than about 1.3 mm, such as less than about 1.2 mm, such as less than about 1.1 mm, such as less than about 1 mm, such as less than about 0.9 mm, such as less than about 0.8 mm, such as less than about 0.7 mm.

The raised pattern elements 12 and 14 as shown in FIG. 1 occupy a certain amount of surface area in relation to the void areas 16. The surface area can be altered and controlled based upon the type of application for which the nonwoven web 10 is to be used. In general, the raised pattern elements 12 and 14 occupy greater than about 8% of the total surface area, such as greater than about 10% of the total surface area, such as greater than about 15% of the total surface area, such as greater than about 20% of the total surface area, such as greater than about 25% of the total surface area, such as greater than about 30% of the total surface area, such as greater than about 35% of the total surface area, such as greater than about 40% of the total surface area, such as greater than about 45% of the total surface area, such as greater than about 50% of the total surface area, such as greater than about 55% of the total surface area, such as greater than about 60% of the total surface area, such as greater than about 65% of the total surface area. The raised elements generally occupy less than about 80% of the total surface area of the nonwoven material 10, such as less than about 75% of the total surface area, such as less than about 70% of the total surface area, such as less than as about 65% of the total surface area, such as less than about 60% of the total surface area, such as less than about 55% of the total surface area, such as less than about 50% of the total surface area, such as less than about 45% of the total surface area, such as less than about 40% of the total surface area.

The fibers that are used to form the nonwoven material 10 can also vary depending upon the particular application. The fibers incorporated into the nonwoven material 10, for instance, can comprise cellulose fibers alone, synthetic polymer fibers alone, or a mixture of cellulose fibers and synthetic polymer fibers.

Cellulosic fibers that may be incorporated into the material include but not limited to nonwoody fibers (including bast fibers), such as cotton, abaca, kenaf, sabai grass, flax, esparto grass, straw, jute hemp, bagasse, milkweed floss fibers, and pineapple leaf fibers; and woody or pulp fibers such as those obtained from deciduous and coniferous trees, including softwood fibers, such as northern and southern softwood kraft fibers; hardwood fibers, such as eucalyptus, maple, birch, and aspen. Pulp fibers can be prepared in high-yield or low-yield forms and can be pulped in any known method, including kraft, sulfite, high-yield pulping methods and other known pulping methods. Fibers prepared from organosolv pulping methods can also be used. The cellulosic pulp fibers described above, for instance, can have an average fiber length of less than about 8 mm, such as less than about 6 mm, such as less than about 4 mm. The average fiber length of the cellulosic pulp fibers is generally greater than about 1 mm, such as greater than about 2 mm, such as greater than about 3 mm.

Other cellulosic fibers that can be incorporated into the material include any suitable regenerated cellulose fibers including rayon fibers, viscose fibers, model fibers, lyocell fibers, and the like. The regenerated cellulose fibers, cotton fibers, and various other bast fibers can generally have longer fiber lengths than pulp fibers. For instance, the fibers can comprise staple fibers and can have a fiber length of from about 8 mm to about 70 mm. The fiber length, for instance, can be greater than about 10 mm, such as greater than about 12 mm, such as greater than about 14 mm, and generally less than about 60 mm, such as less than about 50 mm, such as less than about 40 mm, such as less than about 30 mm.

As described above, the nonwoven material 10 can contain synthetic polymer fibers alone or in combination with cellulose fibers. The synthetic polymer fibers can comprise any suitable fiber, including polyester fibers, nylon fibers, polyolefin fibers, and the like. The synthetic polymer fibers can comprise virgin fibers, recycled fibers, or mixtures thereof.

The synthetic polymer fibers, such as polyester fibers, can have any suitable size. In one embodiment, relatively fine fibers are used. For instance, the synthetic polymer fibers can have a denier of less than about 10, such as less than about 8, such as less than about 6, such as less than about 5, such as less than about 4, such as less than about 3, such as less than about 2. In one aspect, the synthetic polymer fibers can have a denier of from about 0.8 to about 2.5, such as from about 1 to about 2. In an alternative embodiment, the synthetic polymer fibers can have a denier of less than about 1.5, such as less than about 1.3, such as less than about 1, such as less than about 0.8, and generally greater than about 0.3.

In one aspect, the synthetic polymer fibers contained in the nonwoven material can all have the same size. In an alternative embodiment, a mixture of different polymeric synthetic fibers can be incorporated into the nonwoven material. In one aspect, for instance, the nonwoven material can contain a first polyester fiber that has a size larger than a second polyester fiber. The first polyester fiber, for instance, can have a size of from about 0.5 denier to about 5 denier, such as from about 0.8 denier to about 1.5 denier. The second polyester fiber, on the other hand, can have a size less than about 1.5 denier, such as less than about 1.2 denier, such as less than about 1.0 denier, and generally greater than about 0.5 denier, such as greater than about 0.7 denier.

In one embodiment, the nonwoven material 10 can be made exclusively from cellulose fibers. The cellulose fibers can comprise all of the same fibers or can comprise a blend or mixture of different cellulose fibers. For instance, the nonwoven material can contain cellulose pulp fibers combined with cotton fibers, regenerated cellulose fibers, bast fibers, or mixtures thereof.

Alternatively, the nonwoven material can be made exclusively from synthetic polymer fibers, such as polyester fibers. The nonwoven material can contain a single synthetic polymer fiber or can contain a mixture of different synthetic polymer fibers. As described above, in one embodiment, the nonwoven material can be made from two different types of polyester fibers having different sizes. The fiber length can also vary. In general, synthetic polymer fibers are staple fibers having any length as desired. In general, the fibers have a length of less than about 100 mm, such as less than about 50 mm, such as less than about 30 mm, such as less than about 20 mm, such as less than about 15 mm. The fiber length is generally greater than about 3 mm, such as greater than about 5 mm, such as greater than about 8 mm. In one aspect, longer fibers may be used that have a fiber length of greater than about 15 mm, such as greater than about 25 mm.

In one embodiment, the nonwoven material 10 can be made from a mixture of cellulose fibers and synthetic polymer fibers. The cellulose fibers and/or the synthetic polymer fibers can comprise any of the fibers described above or any of the described above fiber mixtures. The cellulose fibers can be present in the nonwoven web generally in an amount greater than about 10% by weight, such as in an amount greater than about 20% by weight, such as in an amount greater than about 30% by weight, such as in an amount greater than about 35% by weight, such as in an amount greater than about 40% by weight, such as in an amount greater than about 45% by weight, such as in an amount greater than about 50% by weight, such as in an amount greater than about 55% by weight, such as in an amount greater than about 60% by weight, such as in an amount greater than about 65% by weight, such as in an amount greater than about 70% by weight, such as in an amount greater than about 75% by weight. The cellulose fibers can be present in the nonwoven material generally in an amount less than about 95% by weight, such as in an amount less than about 90% by weight, such as in an amount less than about 85% by weight, such as in an amount less than about 80% by weight, such as in an amount less than about 70% by weight, such as in an amount less than about 60% by weight, such as in an amount less than about 50% by weight, such as in an amount less than about 40% by weight, such as in an amount less than about 30% by weight.

The synthetic polymer fibers can be present in the nonwoven material 10 in an amount greater than about 5% by weight, such as in an amount greater than about 10% by weight, such as in an amount greater than about 15% by weight, such as in an amount greater than about 20% by weight, such as in an amount greater than about 25% by weight, such as in an amount greater than about 30% by weight, such as in an amount greater than about 35% by weight, such as in an amount greater than about 40% by weight, such as in an amount greater than about 45% by weight. The synthetic polymer fibers can be present in the nonwoven material 10 generally in an amount less than about 85% by weight, such as in an amount less than about 80% by weight, such as in an amount less than about 70% by weight, such as in an amount less than about 60% by weight, such as in an amount less than about 55% by weight, such as in an amount less than about 50% by weight, such as in an amount less than about 45% by weight, such as in an amount less than about 40% by weight, such as in an amount less than about 30% by weight, such as in an amount less than about 15% by weight, such as in an amount less than about 10% by weight.

In one particular embodiment, the nonwoven material 10 includes cellulose pulp fibers, such as softwood fibers and/or hardwood fibers, in an amount from about 40% to about 60% by weight and contains polyester fibers in an amount from about 40% to about 60% by weight. The polyester fibers can comprise first polyester fibers having a size of from about 1 denier to about 2 denier and a second polyester fiber having a size of from about 0.3 denier to about 0.8 denier.

In some embodiments, binder materials can be incorporated into the nonwoven material. Binder materials that may be used in the present disclosure can include, but are not limited to, thermoplastic binder fibers, such as PET/PE bicomponent binder fiber, and water-compatible adhesives or wet strength agents such as, for example, latexes. In some embodiments, binder materials as used herein can be in powder form, for example, such as thermoplastic PE powder. Importantly, the binder can comprise one that is water insoluble on the dried substrate. In certain embodiments, latexes used in the present disclosure can be cationic or anionic to facilitate application to and adherence to cellulosic fibers that can be used herein. For instance, latexes believed suitable for use include, but are not limited to, anionic styrene-butadiene copolymers, polyvinyl acetate homopolymers, vinyl-acetate ethylene copolymers, vinyl-acetate acrylic copolymers, ethylene-vinyl chloride copolymers, ethylene-vinyl chloride-vinyl acetate terpolymers, acrylic polyvinyl chloride polymers, acrylic polymers, nitrile polymers, as well as other suitable anionic latex polymers known in the art. Examples of such latexes are described in U.S. Pat. No. 4,785,030 to Hager, U.S. Pat. No. 6,462,159 to Hamada, U.S. Pat. No. 6,752,905 to Chuang et al., which are incorporated herein by reference.

Examples of other wet strength agents include polymeric aldehyde-functional compounds such as glyoxylated polyacrylamide, such as a cationic glyoxylated polyacrylamide. Such compounds include PAREZ 631 NC wet strength resin available from Cytec Industries of West Patterson, N.J., chloroxylated polyacrylamides, and HERCOBOND 1366, manufactured by Hercules, Inc. of Wilmington, Del. Another example of a glyoxylated polyacrylamide is PAREZ 745, which is a glyoxylated poly (acrylamide-co-diallyl dimethyl ammonium chloride).

Examples of suitable thermoplastic binder fibers include, but are not limited to, monocomponent and multi-component fibers having at least one relatively low melting thermoplastic polymer such as polyethylene. In certain embodiments, polyethylene/polypropylene sheath/core staple fibers can be used. Binder fibers may have lengths in line with those described herein above in relation to staple fibers. Binder fibers can be present in the nonwoven web in an amount greater than about 2% by weight, such as greater than about 5% by weight, such as greater than about 8% by weight, and less than about 40% by weight, such as less than about 30% by weight, such as less than about 20% by weight, such as less than about 10% by weight.

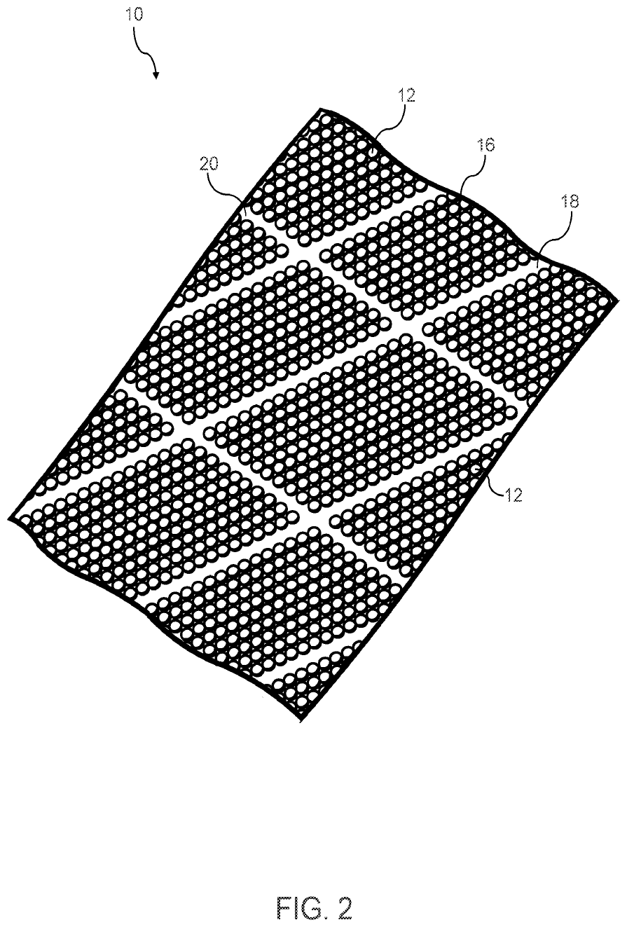

Referring to FIG. 2, another embodiment of a nonwoven material 10 made in accordance with the present disclosure is shown. Like reference numerals have been used to indicate similar elements. In the embodiment illustrated in FIG. 2, the nonwoven material 10 includes raised elements 12 that extend from a base surface 20. Void areas 16 are located between and around the raised elements 12. The raised elements 12 are organized into domains that are separated by contaminant retention zones 18. The contaminant retention zones 18, which form part of the void areas 16, are interconnected in the embodiment illustrated in FIG. 2 and form a grid-like pattern. The grid pattern is skewed or diagonal to a machine direction of the nonwoven material 10.

In the embodiment illustrated in FIG. 2, the raised elements 12 all generally have the same height and circumference. The raised pattern elements 12, however, can occupy a similar amount of surface area in comparison to the raised elements 12 and 14 as shown in FIG. 1.

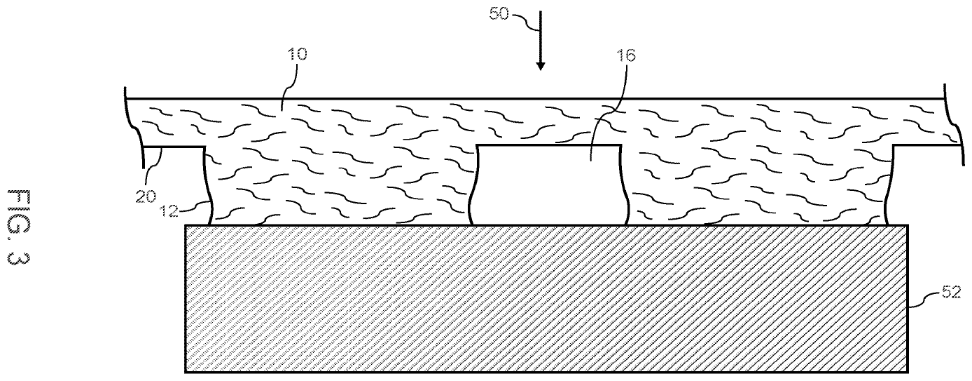

In accordance with the present disclosure, the nonwoven material 10 can be constructed so as to have dramatically improved cleaning efficiency against all different types of contaminants. The nonwoven material of the present disclosure is particularly well suited to wiping up and retaining greases and/or oils. As shown in FIGS. 1 and 2, the nonwoven web has a controlled topography including a pattern of raised elements. The perimeter or circumference of each raised element forms an edge that has been found to improve the cleaning properties of the nonwoven material. More particularly, the edges of the raised elements work in conjunction with the void surface area located between the base surface and the top of the raised elements to engage and capture contaminants. In addition, the fibers used to form the nonwoven material 10 and the manner in which the nonwoven material 10 is constructed also can lead to improved cleaning properties. For instance, the topography of the nonwoven material 10 can be constructed to maintain its structure when used, such as when pressure is being applied to the nonwoven material against an adjacent surface. In this regard, various parameters of the nonwoven material 10 can be measured while under a pressure that simulates the pressure applied to the nonwoven material during use. For example, referring to FIG. 3, a cross-section of the nonwoven material 10 as shown in FIG. 2 is illustrated. The nonwoven material 10 includes raised elements 12 that extend from a base surface 20. Void areas are created between and around the raised elements 12.

Referring to FIG. 3, the nonwoven material 10 is shown against an adjacent surface 52. An arrow 50 represents a pressure being applied to the nonwoven material 10 as would occur during use of the nonwoven material 10 when used as a wiper. In accordance with the present disclosure, various properties of the nonwoven material 10 are determined when a simulated surface pressure is applied to the raised elements 12 of the nonwoven material 10.

For example, two properties that are believed to have an impact on the ability of the nonwoven material to clean up contaminants are the perimeter of the pattern elements and the pattern created void volume. Each of these parameters can be measured at a desired pressure, such as at a pressure of 0.1 psi, 0.3 psi, 0.4 psi, and so forth. In one aspect, the measurements can be conducted while a pressure of 0.3 psi is applied to the nonwoven material.

The perimeter of pattern elements refers to the total distance around the edges of the raised elements 12. In other words, the perimeter of pattern elements is the sum of all perimeters around all raised elements contained on the nonwoven material. As described above, the edges of the raised elements are believed to contribute to the ability of the nonwoven material to engage and pick up contaminants. The perimeter of pattern elements can be normalized on a per area basis. In one aspect, the perimeter of pattern elements per area on the nonwoven material can be greater than about 0.08/mm (mm/mm²), such as greater than about 0.09/mm, such as greater than about 0.1/mm, such as greater than about 0.11/mm, such as greater than about 0.12/mm, and generally less than about 0.3/mm, such as less than about 0.2/mm, such as less than about 0.18/mm, such as less than about 0.16/mm, when tested at a pressure of 0.3 psi.

Another property to be measured under pressure is the pattern created void volume which refers to the void areas 16 as shown in FIGS. 1 and 2 and can be measured from the base surface 20 to the tops of the raised pattern elements 14. This void volume, especially at pressures of use, creates spaces to accumulate contaminates that come into contact with the edges of the raised elements. When measured at 0.3 psi, nonwoven materials made according to the present disclosure can display a pattern created void volume per surface area of greater than about 1.1 mm, such as greater than about 1.2 mm, such as greater than about 1.3 mm, such as greater than about 1.4 mm, such as greater than about 1.5 mm, such as greater than about 1.6 mm, and generally less than about 3 mm, such as less than about 2.5 mm, such as less than about 2.2 mm, such as less than about 2 mm.

Other parameters that can impact the cleaning properties of the nonwoven web include the void volume of the nonwoven web. This parameter determines the amount of open space within the interstices of the nonwoven web. The void volume (can also be referred to as the intrinsic void volume) of the nonwoven web, for instance, can generally be greater than about 75%, such as greater than about 78%, such as greater than about 80%, such as greater than about 82%, and generally less than about 96%, such as less than about 90%. The void volume of the nonwoven material can be measured under pressure, such as at a pressure of 0.3 psi.

The void volume of the nonwoven web per surface area can be greater than about 0.2 mm (mm³/mm²), such as greater than about 0.25 mm, such as greater than about 0.28 mm, such as greater than about 0.3 mm, such as greater than about 0.31 mm and less than about 0.6 mm, such as less than about 0.55 mm, such as less than about 0.5 mm, such as less than about 0.45 mm, such as less than about 0.4 mm. The void volume or the porosity of the nonwoven web can be adjusted and controlled based upon the fibers that are used to make up the web and the process by which the web is formed.

Nonwoven materials made according to the present disclosure can generally have a density of greater than about 0.1 g/cm³ when tested at a pressure of 0.05 psi. The density of the nonwoven web, for instance, can be greater than about 0.12 g/cm³ and less than about 2 g/cm³, such as less than about 1.8 g/cm³, such as less than about 0.14 g/cm³.

The caliper of the web can generally be from about 0.4 mm to about 3 mm, including all increments of 0.1 mm therebetween. For instance, the caliper of the web can be greater than about 0.5 mm, such as greater than about 0.6 mm, such as greater than about 0.8 mm. The caliper can be less than about 1.8 mm, such as less than about 1.6 mm, such as less than about 1.5 mm, such as less than about 1.3 mm, such as less than about 1.1 mm, such as less than about 1 mm. The caliper can be measured at an applied pressure of 0.05 psi.

The basis weight of nonwoven materials made in accordance with the present disclosure can be anywhere from about 20 gsm to about 500 gsm, including all increments of 1 gsm therebetween. In many applications, however, the basis weight can be relatively low. In particular, the basis weight of nonwoven materials made according to the present disclosure can be much less than the basis weight of conventional cloth materials while still having the same cleaning abilities with respect to many contaminants, such as grease and oil. For example, in one aspect, the basis weight can be less than about 120 gsm, such as less than about 100 gsm, such as less than about 90 gsm, such as less than about 80 gsm, such as less than about 75 gsm, such as less than about 70 gsm, such as less than about 65 gsm. The basis weight is generally greater than about 25 gsm, such as greater than about 35 gsm, such as greater than about 40 gsm, such as greater than about 45 gsm, such as greater than about 50 gsm.

The raised elements of the nonwoven material as shown in FIG. 3 can be formed using various processes. In the embodiment illustrated in FIG. 3, the raised elements 12 are shown to have a greater basis weight than the portions of the nonwoven material that correspond to the void areas 16. For example, the raised areas can have a basis weight that is greater than about 10%, such as greater than about 20%, such as greater than about 30%, such as greater than about 40%, such as greater than about 50%, such as greater than about 60% of the basis weight of the base surface of the nonwoven material. The basis weight of the raised areas can be up to about 100% greater than the basis weight of the base surface, such as up to about 90% greater than the basis weight of the base surface.

The nonwoven material as shown in FIGS. 1 and 2 can be made in numerous and diverse ways. For instance, the nonwoven material can be made according to a wet lay process, an air lay process, a foam forming process, or the like. The raised elements and topography can be produced using various different techniques, such as hydroentangling and/or applying pressure or suction forces to the web on a patterned forming surface.

In one embodiment, for instance, the nonwoven material of the present disclosure is produced according to a foam-forming process. There are many advantages and benefits to a foam forming process. During a foam forming process, water is replaced with foam as the carrier for the fibers that form the web. The foam, which represents a large quantity of air, is blended with the cellulose and/or polymer synthetic fibers. Since less water is used to form the web, less energy is required in order to dry the web. In addition, foam forming processes are more amenable to producing nonwoven materials containing different types of fibers, especially longer synthetic polymer fibers. In addition, surface topography can be incorporated into the nonwoven material similar to the embodiment as shown in FIG. 3 in which the raised elements have a greater basis weight than the surrounding area of the web. In addition, foam forming processes can create unique fiber orientation. For example, when producing nonwoven materials from a combination of shorter fibers (such as pulp fibers) and longer fibers (such as synthetic polymer or regenerated cellulose staple fibers), the shorter fibers tend to accumulate in the raised elements while the longer fibers can have a greater density along the base surface. This structure produces a nonwoven material having greater fiber density and absorbency in the raised elements while having significant strength in between the raised elements.

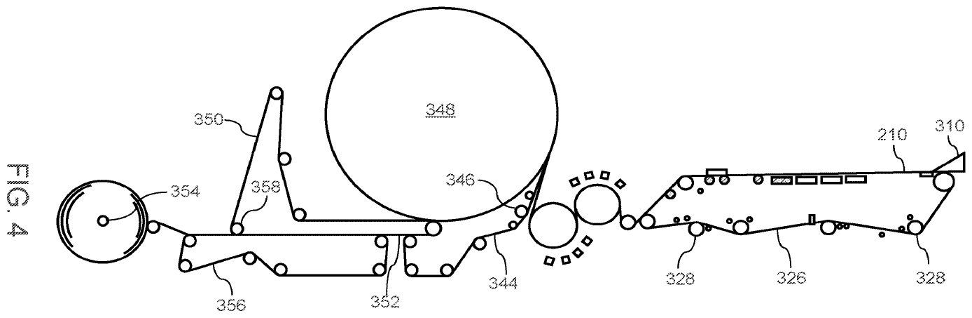

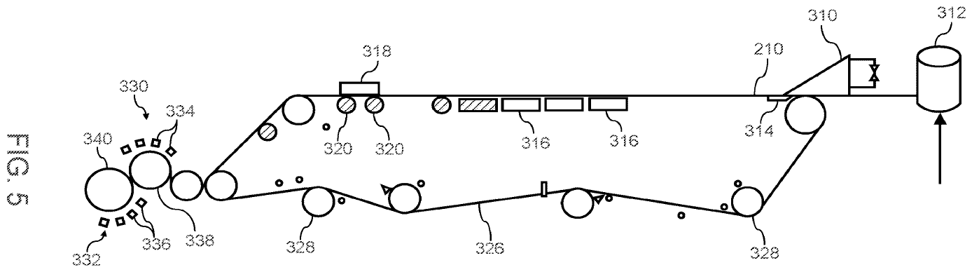

In one particular embodiment, as shown in FIGS. 4 and 5, for exemplary purposes only, the nonwoven material of the present disclosure can be produced using a foam forming process in combination with a hydroentangling step that produces the raised elements. The hydroentangling step, for instance, can occur on a patterned forming surface that matches the resulting pattern or topography of the nonwoven material.

Initially, a fiber furnish is selected for producing the nonwoven material. As described above, the fiber furnish can contain only cellulose fibers, only synthetic polymer fibers, or a mixture of both. During foam forming, the fiber furnish is combined with a foam created by blending water with a foaming agent.

The foaming agent, for instance, may comprise any suitable surfactant. In one embodiment, for instance, the foaming agent may comprise sodium lauryl sulfate, which is also known as sodium laureth sulfate or sodium lauryl ether sulfate. In one embodiment, the foaming agent is a nonionic surfactant which may comprise an alkyl polyglycoside. The foaming agent, for instance, can be a C8 alkyl polyglycoside, a C10 alkyl polyglycoside, or a mixture of C8 and C10 alkyl polyglycosides.

Other foaming agents include sodium dodecyl sulfate or ammonium lauryl sulfate. In other embodiments, the foaming agent may comprise any suitable cationic and/or amphoteric surfactant. For instance, other foaming agents include fatty acid amines, amides, amine oxides, fatty acid quaternary compounds, and the like.

The foaming agent is combined with water generally in an amount greater than about 0.1% by weight, such as in an amount greater than about 1% by weight, such as in an amount greater than about 2% by weight, such as in an amount greater than about 3% by weight. One or more foaming agents are generally present in an amount less than about 50% by weight, such as in an amount less than about 10% by weight, such as in an amount less than about 8% by weight, such as in an amount less than about 4% by weight.

Once the foaming agent and water are combined, the mixture is blended or otherwise subjected to forces capable of forming a foam. A foam generally refers to a porous matrix, which is an aggregate of hollow cells or bubbles which may be interconnected to form channels or capillaries.

The foam density can vary depending upon the particular application and various factors including the fiber furnish used. In one embodiment, for instance, the foam density of the foam can be greater than about 200 g/L, such as greater than about 250 g/L, such as greater than about 300 g/L. The foam density is generally less than about 600 g/L, such as less than about 500 g/L, such as less than about 400 g/L, such as less than about 350 g/L. In one embodiment, for instance, a lower density foam is used having a foam density of generally less than about 350 g/L, such as less than about 340 g/L, such as less than about 330 g/L. The foam will generally have an air content of greater than about 30%, such as greater than about 40%, such as greater than about 50%, such as greater than about 60%. The air content is generally less than about 80% by volume, such as less than about 70% by volume, such as less than about 65% by volume.

In order to form the nonwoven web, the foam is combined with the selected fiber furnish in conjunction with any auxiliary agents. The foamed suspension of fibers is then pumped to a tank and from the tank is fed to a headbox. FIGS. 4 and 5, for instance, show one embodiment of a process in accordance with the present disclosure for forming the web. As shown particularly in FIG. 5, the foamed fiber suspension can be fed to a tank 312 and then fed to the headbox 310. From the headbox 310, the foamed fiber suspension is issued onto an endless traveling forming fabric 326 supported and driven by rolls 328 in order to form a web 210. As shown in FIG. 5, a forming board 314 may be positioned below the web 210 adjacent to the headbox 310. Once formed on the forming fabric 326, the foam formed web can have a consistency of less than about 50%, such as less than about 20%, such as less than about 10%, such as less than about 5%. In fact, the forming consistency can be less than about 2, such as less than about 1.8, such as less than about 1.5. The forming consistency is generally greater than about 0.5, such as greater than about 0.8. The forming consistency indicates the ability to produce webs according to the present disclosure while minimizing the amount of water needed during formation.

Once the wet web is formed on the forming fabric 326, the web is conveyed downstream and dewatered. For instance, the process can optionally include a plurality of vacuum devices 316, such as vacuum boxes and vacuum rolls. The vacuum boxes assist in removing moisture from the newly formed web 210.

As shown in FIG. 5, the forming fabric 326 may also be placed in communication with a steambox 318 positioned above a pair of vacuum rolls 320. The steambox 318, for instance, can increase dryness and reduce cross-directional moisture variance. The applied steam from the steambox 318 heats the moisture in the wet web 210 causing the water in the web to drain more readily, especially in conjunction with the vacuum rolls 320. From the forming fabric 326, the newly formed web 210, in the embodiment shown in FIG. 4, is conveyed downstream, subjected to hydroentangling, and dried on a through-air dryer.

After the foam formed web has been produced, the web is subjected to one or more hydroentangling steps. In the embodiment illustrated in FIG. 5, for instance, the web 210 is subjected to two different hydroentangling steps. In particular, in FIG. 5, the web 210 is hydroentangled on a first surface during a first hydroentangling step and then hydroentangled on a second and opposite surface during a second hydroentangling step. As shown in FIG. 5, for example, the process can include a first hydroentangling device 330 and a second hydroentangling device 332. The hydroentangling that occurs at each hydroentangling station may be accomplished utilizing conventional hydroentangling equipment. The hydroentangling of the foam formed web may be carried out with any appropriate working fluid such as, for example, water. The working fluid flows through a manifold which evenly distributes the fluid through a series of individual holes or orifices. Exemplary holes or orifices, for example, can have a diameter of from about 0.003 inches to about 0.015 inches. For example, the manifold may include a strip of orifices having a diameter of 0.007 inches. The manifold may contain about 20 to about 40 holes per inch and can include 1 to 3 rows of holes. Many other manifold configurations and combinations may be used. In the embodiment illustrated in FIG. 5, for instance, the hydroentangling device 330 includes a plurality of injectors 334, while the hydroentangling device 332 includes a plurality of injectors 336. The injectors 334 and 336 can be part of the manifold and can be in communication with a working fluid supply.

During the hydroentangling process, the working fluid can pass through the orifices at pressures ranging from about 200 psig to about 3,500 psig. At the upper ranges of the described pressures, it is contemplative that the web may be processed at speeds of from about 500 ft/min to about 2000 ft/min. The fluid impacts the material or web which can be supported on a foraminous surface or wire or may be supported on a porous drum surface. In the embodiment illustrated in FIG. 5, for instance, hydroentangling occurs on a first drum 338 and a second drum 340.

The web 210 can be placed directly onto the surface of the drum 338 and on the surface of the drum 340 during hydroentangling. Each drum can include a plurality of openings or vacuum passages for withdrawing excess water. These openings or vacuum passages can also create a pattern into the web 210 during the hydroentangling process. For example, a pattern can be formed into one surface of the web at the first hydroentangling station and a pattern can be formed into the second and opposite surface of the web at the second hydroentangling station. The pattern formed into each surface of the web 210 can be a pattern made according to the present disclosure, such as the pattern illustrated in FIG. 1 or the pattern illustrated in FIG. 2.

In addition to forming a desired topography and improving the cleaning properties of the nonwoven material 210, the one or more hydroentangling stations can also significantly improve various physical properties of the web 210, such as the integrity of the web. For example, the columnar jets of working fluid which directly impact the surfaces of the web serve to entangle and intertwine the fibers contained in the web, especially the freed yarn sections and freed fibers. The hydroentangling processes ultimately form a coherent entangled matrix. The hydroentangling steps also further serve to create a substantially homogeneous fiber mixture within the web. The resulting hydroentangled web, for instance, is “non-layered” and contains no distinguishable separate fibrous layers over the thickness of the web.

Once the foam formed web 210 is hydroentangled one or more times, the web can be dried using a non-compressive drying operation. For example, as shown in FIG. 4, the foam formed web can be dried using a through-air dryer.

Referring to FIG. 4, the foam formed and hydraulically entangled web 210 is transferred from the drum 340 to a throughdrying fabric 344 with the aid of a vacuum transfer roll 346 or a vacuum transfer shoe. If desired, the throughdrying fabric can be run at a slower speed than the web 210 to further enhance stretch. Transfer can be carried out with vacuum assistance to ensure deformation of the sheet to conform to the throughdrying fabric, thus yielding desired bulk and appearance if desired.

In the embodiment illustrated in FIG. 4, the foam formed web 210 is transferred to a throughdrying fabric 344. Alternatively, the foam formed web can be transferred to a metal, porous sleeve that forms the circumference of the throughdryer 348. The use of a metal sleeve instead of a fabric may provide various advantages. For instance, a porous metal sleeve may further create porosity for increasing the liquid absorbent properties of the web.

Alternatively, the foam formed web 210 can be conveyed on the throughdrying fabric 344 over the circumference of the throughdryer 348. The throughdrying fabric can contain high and long impression knuckles. For example, the throughdrying fabric can have about from about 5 to about 300 impression knuckles per square inch which are raised at least about 0.005 inches above the plane of the fabric. During drying, the web can be further macroscopically arranged to conform to the surface of the throughdrying fabric. Flat surfaces, however, can also be used in the present disclosure.

The side of the web contacting the throughdrying fabric is typically referred to as the “fabric side” of the nonwoven web. The fabric side of the nonwoven web, as described above, may have a shape that conforms to the surface of the throughdrying fabric after the fabric is dried in the throughdryer. The opposite side of the nonwoven web, on the other hand, is typically referred to as the “air side”. The air side of the web is typically smoother than the fabric side during normal throughdrying processes.

The level of vacuum used for the web transfers can be from about 3 to about 15 inches of mercury (75 to about 380 millimeters of mercury), preferably about 5 inches (125 millimeters) of mercury. The vacuum shoe or roll (negative pressure) can be supplemented or replaced by the use of positive pressure from the opposite side of the web to blow the web onto the next fabric in addition to or as a replacement for sucking it onto the next fabric with vacuum.

The web is finally dried to a consistency of about 94 percent or greater by the throughdryer 348 and thereafter transferred to a carrier fabric 350. The dried basesheet 352 is transported to the reel 354 using carrier fabric 350 and an optional carrier fabric 356. An optional pressurized turning roll 358 can be used to facilitate transfer of the web from carrier fabric 350 to fabric 356. Suitable carrier fabrics for this purpose are Albany International 84M or 94M and Asten 959 or 937, all of which are relatively smooth fabrics having a fine pattern. Although not shown, reel calendering or subsequent off-line calendering can be used to improve the smoothness and softness of the basesheet.

The process of the present disclosure can also produce webs with good bulk characteristics. The bulk, for instance, can generally be greater than about 3 cc/g, such as greater than about 5 cc/g, such as greater than about 8 cc/g, such as greater than about 10 cc/g, such as greater than about 12 cc/g, and generally less than about 20 cc/g, such as less than about 15 cc/g.

In the embodiment illustrated in FIGS. 4 and 5, the foam formed web is hydroentangled on a patterned forming surface in order to form the raised elements. In other embodiments, however, a suction force positioned below the forming surface can be used to form the raised elements. These processes produce raised elements where the raised elements have an increased basis weight in comparison to the base surface of the web. Texture can also be imparted to a web through embossing. When a web is embossed, however, the basis weight of the web remains uniform and does not create raised elements with increased basis weight.

The present disclosure may be better understood with reference to the following example.

### Example No. 1

A nonwoven material was made in accordance with the present disclosure similar to the embodiment illustrated in FIG. 2. The nonwoven material was made through a process similar to that illustrated in FIGS. 4 and 5. The fiber furnish used to produce the web contained 60% by weight softwood pulp fibers combined with 40% by weight polyester fibers. The polyester fibers included 50% by weight 0.5 denier fibers and 50% by weight 1.5 denier fibers. The raised elements occupied 38.9% of the total surface area of the nonwoven web. The raised elements had a circumference of from about 2 mm to about 2.5 mm. The contaminant retention zones on the surface of the nonwoven material had a width of about 2.15 mm.

Initially, the above web was simulated using software for determining grease and oil cleaning performance. From the simulation, the following results were obtained:

| | Mean Oil | Mean Oil | Mean | Mean Grease |
|---|---|---|---|---|
| Height of | Absorbed | Contained on | Grease | Contained on |
| Raised | in | the Surface | Absorbed in | the Surface of |
| Elements | Material | of the Nonwoven | Material | the Nonwoven |
| (mm) | (g/g) | Material (g/g) | (g/g) | Material (g/g) |
| 0.7 | 0.6081 | 0.0001 | 0.2527 | 0.0002 |
| 1 | 0.6713 | 0.0001 | 0.2950 | 0.0004 |

As shown above, the simulation was conducted at different heights of the raised elements. The results were normalized in units of grams of contaminant per gram of nonwoven material. The basis weight of the nonwoven material was inputted at 65 gsm.

Based upon the simulation, the 65 gsm nonwoven material performed just as well as a woven or knitted cloth having a much higher basis weight, such as a basis weight of 200 gsm.

In addition to the simulated test, the nonwoven material having a basis weight of 65 gsm was also produced and tested for various properties. The tests were conducted at different pressures applied to the nonwoven material. The following results were obtained:

| | | | Pattern | Perimeter | Void |
|---|---|---|---|---|---|
| | | | Created | of Pattern | Volume |
| | Applied | % | Void Volume | Elements | Per |
| Sample | Pressure | Void | Per Surface | Per Surface | Surface |
| No. | (psi) | Volume | Area (mm) | Area (1/mm) | Area (mm) |
| 1 | 0.0 | 86.0 | 4.12 | 0.040 | 0.41 |
| 2 | 0.1 | 87.2 | 2.13 | 0.105 | 0.31 |
| 3 | 0.3 | 84.5 | 1.67 | 0.129 | 0.32 |
| 4 | 0.5 | 83.6 | 1.74 | 0.099 | 0.35 |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. A wiping product comprising:
a nonwoven web having a first surface and a second and opposite surface, the nonwoven web comprising cellulose fibers, synthetic polymer fibers, or mixtures thereof;
the nonwoven web having a basis weight of less than about 110 gsm;
a topographical pattern located on the first surface of the nonwoven web, at least a portion of the topographical pattern including raised pattern elements that extend from a base surface; and
wherein the raised pattern elements produce a perimeter of pattern elements per surface area of greater than about 0.08/mm and produce a pattern created volume per surface area of greater than about 1.1 mm when tested at 0.3 psi.

2. A wiping product as defined in claim 1, wherein the raised pattern elements produce a perimeter of pattern elements per surface area of greater than about 0.09/mm, such as greater than about 0.1/mm, such as greater than about 0.11/mm, such as greater than about 0.12/mm when tested at 0.3 psi.

3. A wiping product as defined in claim 1, wherein the raised pattern elements produce a pattern created volume per surface area of greater than about 1.3 mm, such as greater than about 1.4 mm, such as greater than about 1.5 mm, such as greater than about 1.6 mm when tested at 0.3 psi.

4. A wiping product as defined in claim 1, wherein the nonwoven web has a void volume of greater than about 75%, such as greater than about 78%, such as greater than about 80%, such as greater than about 82% when tested at 0.3 psi.

5. A wiping product as defined in claim 1, wherein the raised pattern elements have a basis weight and the base surface has a basis weight and wherein the basis weight of the raised pattern elements is greater than about 10%, such as greater than about 20%, such as greater than about 30%, such as greater than about 40% than the basis weight of the base surface.

6. A wiping product as defined in claim 1, wherein the raised pattern elements of the pattern comprise discrete shapes that are not interconnected.

7. A wiping product as defined in claim 1, wherein the raised pattern elements comprise raised circular elements.

8. A wiping product as defined in claim 7, wherein the circular elements have a perimeter of from about 0.5 mm to about 20 mm, such as from about 0.75 mm to about 10 mm, such as from about 1 mm to about 3 mm.

9. A wiping product as defined in claim 1, wherein the raised pattern elements form raised pattern zones that border contaminant retention zones, the contaminant retention zones being planar.

10. A wiping product as defined in claim 9, wherein the contaminant retention zones are discrete zones that are not interconnected.

11. A wiping product as defined in claim 1, wherein the nonwoven web has a density of from about 0.1 g/cm3 to about 0.18 g/cm3, such as from about 0.12 g/cm3 to about 0.14 g/cm3.

12. A wiping product as defined in claim 1, wherein at least a portion of the raised pattern elements have a height of greater than about 0.1 mm and generally less than about 1.2 mm.

13. A wiping product as defined in claim 1, wherein the raised pattern elements are spaced an average distance of from about 0.5 mm to about 1.5 mm apart.

14. A wiping product as defined in claim 1, wherein the nonwoven web has a caliper of greater than about 0.4 mm and less than about 1.3 mm.

15. A wiping product as defined in claim 1, wherein the nonwoven web has a basis weight of from about 35 gsm to about 100 gsm.

16. A wiping product as defined in claim 1, wherein the non-woven web contains the synthetic polymer fibers in an amount of from about 15% to about 60% by weight and contains the cellulose fibers in an amount of from about 40% to about 85% by weight.

17. A wiping product as defined in claim 1, wherein the non-woven web comprises a foam formed web.

18. A wiping product as defined in claim 1, wherein the raised pattern elements occupy from about 15% to about 80% of the surface area of the first surface.

19. A wiping product as defined in claim 1, wherein the topographical pattern includes first raised pattern elements and second raised pattern elements, the first raised pattern elements having a perimeter that is less than a perimeter of the second raised pattern elements.

20. A wiping product as defined in claim 1, wherein the synthetic polymer fibers comprise polyester fibers having a fiber size of from about 0.5 denier to about 3.0 denier.

21. A wiping product as defined in claim 1, wherein the synthetic polymer fibers comprise first polyester fibers and second polyester fibers, the first polyester fibers having a fiber size of less than about 1.5 denier, the first polyester fibers having a smaller size than the second polyester fibers.
